(19) United States
(12) Patent Application Publication
(10) Pub. No.: US 2015/0239230 A1
(43) Pub. Date: Aug. 27, 2015

(54) METHOD AND AN APPARATUS FOR DECORATING A PANEL

(71) Applicant: SPANOLUX N.V.- DIV. BALTERIO, Sint-Baafs-Vijve (BE)

(72) Inventor: Bruno Paul Louis Vermeulen, Aldeneik-Maaseik (BE)

(21) Appl. No.: 14/427,500

(22) PCT Filed: Sep. 12, 2013
(86) PCT No.: PCT/EP2013/068932

§ 371 Date: Mar. 11, 2015

(30) Foreign Application Priority Data
Sep. 14, 2012 (EP) 12184516.8

(51) Int. Cl. B41F 19/02

(52) U.S. Cl. CPC B41F 19/02

(57) ABSTRACT

A method of decorating a panel comprises the steps of supplying a panel to a carrier, performing at least a first printing step by means of a first printing module and performing a second printing step by means of a second printing module, wherein the first and second printing steps are performed according to a predetermined positional relationship to form the decorated panel, and wherein during and between the first and second printing steps the panel is held at a substantially fixed position with respect to the carrier.

### CROSS-REFERENCE TO RELATED APPLICATION

This application is a Section 371 National Stage Application of International Application PCT/EP2013/068932 filed Sep. 12, 2013 and published as WO2014/041085 A1 in English.

### BACKGROUND

The discussion below is merely provided for general background information and is not intended to be used as an aid in determining the scope of the claimed subject matter.

An aspect of the invention relates to a method of decorating a panel, comprising the steps of supplying a panel to a carrier, performing at least a first printing step by means of a first printing module and performing a second printing step by means of a second printing module.

Such a method is known from EP 2 363 299. In the known method a decorative basic pattern is printed onto the panel in the first printing step. The panel is transported to a digital printing station for printing a curable substance on the panel in a second printing step so as to decorate the panel. Before arriving at the printing station the basic pattern is recognized by a camera. The decorative basic pattern may be an imitation of natural wood including nerves and knots. The curable substance is printed on the panel and cured afterwards in order to create a texture on the panel that may correspond to the basic pattern, possibly for obtaining embossment in register. In this way a realistic textured surface can be made, corresponding to a natural wood plank, for example. Due to the required recognizing process before the digital printing station the known method appears to be time consuming. Besides, if the pattern of the curable substance should be aligned with the decorative basic pattern an intermediate positioning action of the panel with respect to the carrier and/or the second printing module may be required.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the Background.

An aspect of the invention provides an efficient method of decorating a panel.

This is achieved with the method disclosed herein, in which the first and second printing steps are performed according to a predetermined positional relationship to form the decorated panel, and wherein during and between the first and second printing steps the panel is held at a substantially fixed position with respect to the carrier.

Since the panel remains at a fixed position with respect to the carrier the second printing step can be controlled on the basis of the same coordinates as used for the first printing step. In other words, additional steps of making a separate digital image of a pattern printed in the first printing step, for example by means of a camera as known in the prior art, and for example calculating the coordinates related to that pattern for controlling the second printing step can be omitted. In fact, a single reference set of coordinates can be used to calculate the sets of coordinates that are used for both printing steps. This results in a rapid manufacturing process. The coordinates may be relative to the position of the carrier. The sets of coordinates that are used in the first and second printing steps are not necessarily identical to each other. The desired patterns that are printed in the first and second printing steps may deviate from each other deliberately. However, the method provides the opportunity to use identical coordinates in both printing steps such that the patterns are printed exactly on the same position of the panel, i.e. onto each other. This provides the possibility of performing the printing steps in a continuous process with a high degree of accuracy and in a rapid manner.

The panel may be a floor panel, a wall panel, a ceiling panel, a panel for furniture, packaging or the like and be suitable for interior and/or exterior use. The panel may be rigid or flexible, and it may have numerous dimensions. It may be made of wood-based material like MDF, HDF, WPC, or vinyl, metal, glass, stone, ceramic, textile, non-woven fabric paper, carton, cardboard but also polymeric composite. Furthermore, the panel may be applied onto another substrate, for example by means of laminating.

The panel may be ready for use after performing the method. For example, the panel to be decorated has already the desired dimensions and is already provided with locking means for fixing similar panels to each other, such as grooves and tongues. It is also possible that the panel is an intermediate product after performing the method , for example it should be still cut into smaller pieces and provided with locking means. It is noted that the method may comprise more manufacturing steps before, after and between the first and second printing steps, for example for preparing the panel surface before the printing steps by means of applying a primer, or alternative treatments, such as corona, plasma, pyrolysis, heating and surface activation treatments, or the like, or treatment of the panel surface between or after the printing steps, for example by means of applying a protection layer or the like.

The method is independent from size, material composition or physical properties of the panel. For example, the method may be performed as a roll-to-roll or a panel-to-panel process within a larger production process.

Furthermore, the duration of the first and second printing steps may be different, for example if different quantities of printing matter should be printed in both steps.

The first and/or second printing module and/or any further printing module may comprise one of an inkjet head and a valvejet head and a toner head, such that any sequence and combination of print heads can be selected for any desired embodiment of the method.

Preferably, the carrier has preset positions with respect to a reference point during the first and second printing steps. This means that it is not necessary to determine the actual position of the panel in case the carrier is displaced between the first and second printing steps. For example, with respect to the reference point the location of the panel where the first printing step is performed is different from the location of the panel where the second printing step is performed. It is noted that the actual position of the carrier with respect to the reference point may be controlled, but such a control is independent from the actual position of the panel, or any pattern that is printed thereon during the first printing step, with respect to the carrier. It is also conceivable to print a code on the panel in the first or second printing step, which code is related to the set of coordinates of the corresponding pattern. In a next production step the data can be used for further processing steps. Due to the preset positions of the carrier a high accuracy can be achieved. If the first and second printing modules are digitally controlled the desired patterns to be printed can be changed quickly, which leads to a high degree of flexibility.

During the first and second printing steps the carrier may follow preset paths with respect to the reference point.

In case of the preset positions and/or the preset paths of the carrier, the locations where the first and second printing steps are performed may extend behind each other, for example when applying a conveyor belt as a carrier. It is also conceivable that during the first printing step both the carrier and the first printing module move with respect to the reference point and/or with respect to each other, and/or during the second printing step both the carrier and the second printing module move with respect to the reference point and/or with respect to each other. The accuracy of the preset positions or paths depend on the accuracy of the carrier displacement. In case of a controlled conveyor belt an accuracy of 5 μm or less can be achieved in a direction parallel to the plane of the belt and 100 μm or less in a direction perpendicular thereto.

In a specific embodiment, in the first printing step a decorative basic pattern is printed on the panel and in the second printing step a curable substance is printed on the panel, after which the curable substance is cured. This provides the opportunity to create a textured surface. Consequently, it is not necessary to use relatively expensive press plates or press rollers in order to create an embossed surface on the panel. The second printing step may take more time than the first printing step, since a relatively large quantity of curable substance should be printed in the second printing step. Additional time may be minimized, however, by performing one or more printing steps after the second printing step. In case the curable substance is formed by printing a liquid on the panel, after which a powder is provided to the liquid, such that the powder or the liquid together with the powder form the curable substance, the powder may be a gel powder to reduce the printing time during the second printing step. Furthermore, it is possible to apply dedicated print heads which can print relatively high flows, more than average print heads. For example, valve jets may be applied, but alternative print head types are conceivable.

The curable substance may be printed such that a textured surface is created between side edges of the panel and/or such that at least a side edge of the panel is bevelled. The thickness of the substance after curing may be smaller than 1000 μm, preferably smaller than 500 μm and more preferably smaller than 250 μm. The inclination of the substance after curing may be up to 45°, preferably up to 60°, and more preferably up to 90° with respect to a panel plane.

The positional relationship of the decorative basic pattern and the curable substance pattern may be such that both patterns substantially coincide, partly coincide, or that both patterns are shifted with respect to each other. Furthermore, both patterns may be printed with different materials in order to create different appearances, for example gloss and matt. It is also possible to create different appearances by manipulating the curing process. For example, when applying surface curing instead of the entire liquid curing the surface may become non regular due to crimping behavior. This may cause a matt effect.

Preferably, the curable substance is printed over at least a part of said decorative basic pattern or adjacent to said decorative basic pattern, which provides an embossment-in-register appearance to the panel surface. In the first case the resulting product can obtain an elevation at the pattern printed in the first printing step and in the second case the resulting product can obtain a depression at the pattern printed in the first printing step.

In general terms, the pattern of the curable substance can be printed at a relative position with respect to the decorative basic pattern. This may typically be desired at borders of the decorative basic pattern since a curable substance may create a vague border. This may happen if the distance between borders of the basic pattern and the related pattern of curable substance is too small such that the curable substance spills over the border of the basic pattern before and/or during curing.

The decorative basic pattern may be printed by means of water-based, solvent-based or UV curable ink, lustrous or matt varnish, color ink, clear or transparent ink or the like.

The curable substance may be a photo-polymeric ink which can be cured in a curing station afterwards, but alternative substances are conceivable. It is also possible that the curable substance is formed by printing a liquid or adhesive on the panel, possibly on top of the decorative basic pattern, after which an intermediate substance is provided to the liquid, such that the intermediate substance forms the curable substance or the liquid together with the intermediate substance form the curable substance. The intermediate substance is for example a thermographic powder or a swelling powder. In case of a swelling powder the volume of the substance becomes larger than that of the sum of the liquid and the powder separately during melting and/or curing, hence the elevations of the resulting texture become larger upon curing. The maximum thickness of the substance after curing may vary between 20 and 1000 μm, preferably between 50 and 500 μm, and more preferably between 75 and 250 μm, but a thinner or thicker texture is conceivable.

In case the intermediate substance comprises a thermographic powder, it may be cooled by forced cooling after melting the thermographic powder so as to increase the viscosity of the melted substance rapidly.

In case the curable substance is formed by printing a liquid or adhesive on the panel, after which an intermediate substance is provided to the liquid, such that the intermediate substance forms the curable substance or the liquid together with the intermediate substance form the curable substance, and the intermediate substance comprises a powder, the density of the powder may be increased, for example by means of pressing, rolling, applying a mixture of different powder sizes, or the like.

The powder may be applied by means of an electrostatographic process.

In case the curable substance is formed by printing a liquid or adhesive on the panel, after which an intermediate substance is provided to the liquid, such that the intermediate substance forms the curable substance or the liquid together with the intermediate substance form the curable substance, at least one of the liquid and the curable substance may comprise anti-wear particles, anti-scratch particles, pigments, dyes, metallic particles, or the like.

The liquid that is printed in the second printing step before applying an intermediate substance may comprise a retarder to prolong the drying process of the liquid. This can promote the adhesion between the liquid and the intermediate substance before and/or during curing. Furthermore, the intermediate substance may be liquid, as well. In this case, the prolonged drying properties may be useful to mix the liquids properly.

The liquid that is printed in the second printing step before applying an intermediate substance may have primer properties so as to improve the adhesion between the panel, the liquid, the intermediate substance and any layer covering the panel at the side where the liquid and the intermediate substance are applied.

It is advantageous to apply liquids which have a relatively low heat absorbance capacity, since this may lead to relatively rapid heating of the intermediate substance that is received by the liquid. In case of a powder as intermediate substance, this will melt rapidly. The heat absorbance capacity is preferably lower than that of water. For example, the liquid may contain an alcohol. Consequently, a rapid production process can be achieved, even when the heat absorbance capacity of the panel is relatively high. Furthermore, if the heat capacity of the panel is higher than that of the liquid the risk of adversely affecting the panel surface below the liquid is minimized.

It is noted that melting of powders can be efficiently carried out by means of infrared heating or near infrared curing, since most powders are very good absorbers of infrared energy.

It is possible to concentrate heating to the liquid and the intermediate substance, or separately to the intermediate substance and/or a portion of the panel that contacts the curable substance. In such a case it is possible to select a liquid and/or an intermediate substance that is compatible with the heating source, such as a UV-lamp, a UV-laser, a lamp generating optical radiation, a gas-discharge lamp, IR heating, a normal heater or an electron-beam heater, for example.

In the first printing step a repellent or release agent may be printed on the panel and in the second printing step a curable substance may be printed on the panel, wherein the repellent or release agent is printed at locations where a flow of the curable substance during and/or after the second printing step is hindered or where the substance can be removed after curing. Of course the first printing step can be preceded by a printing step for printing a decoration pattern on the panel. Furthermore, the decoration pattern and the patterns printed in the first and second printing steps may have a predefined positional relationship with respect to each other.

It is also possible that the intermediate substance is printed in the second printing step, for example a fine powder or a toner which can be printed accurately onto a liquid pattern that is printed in the first printing step. It is also possible to print a fine powder or toner directly on the panel in the first and/or second printing step. Experiments have turned out that it is advantageous when the fine powder or toner have thermographic properties.

In practice it is possible that at least an intermediate step of applying an additional layer onto the panel is performed between the first and second printing steps. This does not adversely affect the principle of performing the printing steps according to a predetermined positional relationship accurately, since the panel is held at a fixed position with respect to the same carrier during the first and second printing step as well as between these steps and following steps, if any.

The possibility of applying more manufacturing steps than two printing steps in the method provides the opportunity to obtain a high production speed and to create numerous possible variations of printing. For example, four printing modules may be located behind each other and print the following combinations on a passing panel using the cmyk color model:
cccc-mmmm-yyyy-kkkk
cmyk-cmyk-cmyk-cmyk,
   or a stepped build-up of a textured surface by means of printing clear ink may be created:
clear ink-clear ink-clear ink-clear ink

In the latter case the first two modules may comprises valve jets or dedicated print heads which are able to print relatively large volumes per pass for a rough but fast texture build-up, since valve jets are less accurate, whereas the last two modules may comprise ink jets for more accurate texture build-up. The valve jets, for example, print in 72 dpi, whereas ink jets that have piezo controlled print heads print in 300 dpi or more. The valve jets or alternative print heads make a base layer and the second series of inkjets make a more accurate layer on top of the base layer. The print material may be clear or colored ink, matt or gloss, or the like, whereas intermediate curing may be performed. The number of printing modules is not limited to four, but may be two or more.

The number of printing modules can be selected in relation to the desired speed of production. This is also related to the accuracy of printing. For example, if printing occurs on the basis of color-in-color a higher accuracy is required than printing on the basis of color-on-color.

Furthermore, an increasing speed of the panel with respect to the printing modules requires a higher and more powerful jet speed, particularly if a certain air motion is created at the location of printing due to the relative speed of panel and the printing module. The speed of droplets may then be increased to 5-7 m/s, preferably 8-9 m/s or even higher. At the same time the droplet volume may be reduced, for example below 6 picoliter.

It is noted that different types of liquids may be printed in the second printing step before applying an intermediate substance, wherein the liquids have different absorption properties for receiving the intermediate substance. In this case the different types of liquids may be printed in a third or further printing steps before applying an intermediate substance.

In an alternative embodiment, in the first printing step a curable substance pattern for creating a textured surface is printed on the panel and in the second printing step a decorative pattern is printed on the panel, wherein the curable substance is cured so as to form a textured pattern. This means that the printing steps for creating a decorative pattern and a textured pattern are reversed with respect to the embodiments as described hereinbefore. The curable substance can be cured before or after the second printing step.

In a first example, in the first printing step a textured layer is printed on the panel, for example by means of printing a white ink as a curable substance. After that a decorative pattern is printed in the second printing step, after which a top layer is applied, for example comprising wear resistant substance and/or anti-wear particles and/or anti-scratch particles. The top layer may be applied by means of coating, for example using a roller or a flexible roller, such as a rubber roller. The first printing step may be preceded by a coating step, for example for pre-coating the panel with a white ink, for example the entire upper surface. The textured pattern in the first printing step may be built-up in several separate steps by means of successively printing layers of curable substance. In the second printing step the decorative pattern is printed in a predetermined positional relationship with respect to the textured pattern, for example a decorative pattern is printed on tops of the textured surface that is created in the first printing step. However, a lot of other decorative patterns in relation to the textured surface are possible.

In a second example, it is possible to print the top layer by means of a third printing step. For example, one or more digitally controlled print heads may print a clear ink onto the textured surface. This may create a larger depth effect which is difficult to achieve by using roller coating, for example. It is also possible to selectively print the top layer in relation to one or both the patterns that are printed in the preceding printing steps.

In addition to the latter two examples, it is also possible to apply a top layer on the panel after printing a decorative basic pattern in the first printing step and printing a curable substance in the second printing step for creating a textured surface such as described in several embodiments hereinbefore. In that case it is also possible to apply the top layer by means of roller coating or digital printing in a third printing step. The roller may be textured and/or the panel may be partly coated.

In a further alternative embodiment the following successive steps are conceivable. First create a rough basic textured surface onto a panel by means of coating the panel by means of a textured roller. After that, a decorative pattern can be printed on the panel in a first printing step and a curable substance can be printed in a second printing step by means of digital printing. The texture created in the second printing step may be finer than the rough basic texture.

In general terms, a textured pattern which is created by means of printing a curable substance may be built-up in a number of separate steps by means of successively printing layers of curable substance, and possibly curing between the layers. The printed surface may decrease or increase with growing layers, depending on the desired shape of the textured surface. This can be performed efficiently by means of the method since the same basic dataset of coordinates can be used. Furthermore, it is also possible to vary the substance of the curable substance per layer, such that a great variation in appearance can be achieved, such as matt, gloss, light, dark, pigmented, etc.

The invention is also related to an apparatus for decorating a panel, comprising a carrier for supporting a panel, a retainer for holding the panel at a substantially fixed position with respect to the carrier, a décor printing module for printing a decorative pattern on a panel, an embossment printing module for printing a curable substance, a controller for displacing the carrier, the décor printing module and the embossment printing module with respect to each other and for controlling the amount of printing by the printing modules, wherein the controller is provided with a storage unit for storing coordinates of the pattern which are used for displacing the carrier, the décor printing module and the embossment printing module with respect to each other.

The apparatus does neither need a detection system for detecting a pattern on a panel that is supplied to the carrier nor a separate conversion algorithm for calculating coordinates to control the embossment printing module on the basis of the pattern that was printed by the décor printing module, since the same reference set of coordinates can be used for displacing the carrier, the décor printing module and the embossment printing module with respect to each other.

In a specific embodiment the décor printing module is part of a stationary décor printing station and the embossment printing module is part of a stationary embossment printing station, whereas the carrier is formed by an endless conveyor belt, along which the printing stations are located. Due to the fact that the panel is transported by the conveyor belt from the décor printing station to the embossment printing station and that the stations are located behind each other along one and the same conveyor belt a separate alignment station between the printing stations for aligning the panel with respect to the embossment printing module can be omitted. The décor printing module may be moveable with respect to the stationary décor printing station and the embossment printing module may be movable with respect to the stationary embossment printing station. The apparatus can be controlled such that under operating conditions only a single panel is present in the apparatus, and a next panel is not printed at the décor printing station before the preceding panel has left the embossment printing station. However, it is also possible that panels are printed synchronously at both printing stations.

The belt may have numerous configurations and comprises for example a drivable chain.

The apparatus may comprise an actuator for moving the conveyor belt in a lateral direction with respect to its conveying direction so as to keep the conveyor belt at a predetermined track. This minimizes any deviations between the pattern that is printed by means of the décor printing station and the embossment printing station in case of embossing-in-register.

The retainer may comprise a vacuum system for drawing a panel to the conveyor belt. Alternatively, the retainer may comprise a clamping system or the like.

In more general terms the apparatus may comprise a carrier for supporting a panel, a retainer for holding the panel at a substantially fixed position with respect to the carrier, a first printing module, a second printing module, a controller for displacing the carrier, the first printing module and the second printing module with respect to each other and for controlling the amount of printing by the printing modules, wherein the controller is provided with a storage unit for storing coordinates of a pattern which are used for displacing the carrier, the first printing module and the second printing module with respect to each other. The apparatus is able to perform the method as described hereinbefore, wherein the first printing step is performed by the first printing module and the second printing step by the second printing module.

The controller may adjust the carrier on the basis of one or more sensors for determining the position of the carrier. For example, if the carrier comprises a conveyor belt the sensor(s) may monitor an edge of the belt or markings on the surface of the belt. In this way the position of the conveyor belt may be controlled accurately such that a positioning error in the plane of the belt may be less than 10 μm or even less than 5 μm. Since the panel is held at a substantially fixed position with respect to the belt the positioning error of the panel with respect to a reference point is that small, as well.

In the first printing step a panel to be printed has a fixed position with respect to the carrier. This condition may be achieved by determining the actual position of the panel with respect to the carrier before the first printing step and correcting it, if necessary. Due to the accurate functioning of the carrier it is not necessary to monitor the position of the panel with respect to the carrier during and between the first and second printing steps. If the panel position is adjusted with respect to the carrier before the first printing step, the coordinates used at the first printing step and the second printing step may be corrected in the same way.

The controller may be a central controller including a control algorithm which controls the carrier and the printing modules and possible additional modules together, or the apparatus may comprise two or more separate controllers which communicate with each other and/or with controllers of further apparatus that are connected before the first printing module, after the second printing module or between the first and second printing modules.

It is noted that the décor printing module may be located upstream or downstream of the embossment printing module. Additional printing modules and/or surface treatment modules may be located upstream and/or downstream of the décor printing module and the embossment printing module, for example a roller coating device, a curing device, a third printing module or the like.

The invention is also related to a panel, which is decorated according to the method or the apparatus as described hereinbefore. The invention is also related to a panel, which comprises a substrate, a first print pattern on the substrate and a second print pattern on the substrate, wherein the first and second print patterns have a positional relationship. The positional relationship may be such that when the first and second print pattern are laid onto each other for best matching the deviation between the patterns is less than 10 μm or even less than 5 μm.

In a specific embodiment the second print pattern comprises a textured layer that is elevated above the first print pattern. The second print pattern may match exactly to the first print pattern, but may also follow the first print pattern at a predetermined distance or deliberately deviate from the first print pattern. The first print pattern may be a decorative basic pattern, for example a wood imitating pattern, and the second print pattern may provide additional decorative effects such as glitter, pearlescent, silver, gold, gloss, matt appearance or the like. The panel may be a continuous sheet, as well.

The panel may be suitable for a floor, wall, ceiling, furniture, packaging or the like, and for interior and/or exterior use.

### BRIEF DESCRIPTION OF THE DRAWINGS

The invention will hereafter be elucidated with reference to drawings showing embodiments of the invention very schematically.

FIG. 1 is an illustrative view of an embodiment of an apparatus.

FIG. 2 is a similar view as FIG. 1 of an alternative embodiment.

FIG. 3 is a similar view as FIG. 1 of another alternative embodiment.

FIG. 4 is a similar view as FIG. 1 of still another alternative embodiment.

FIG. 5 is a plan view of a part of a panel on a large scale, which panel is manufactured according to a method disclosed herein.

### DETAILED DESCRIPTION OF THE ILLUSTRATIVE EMBODIMENTS

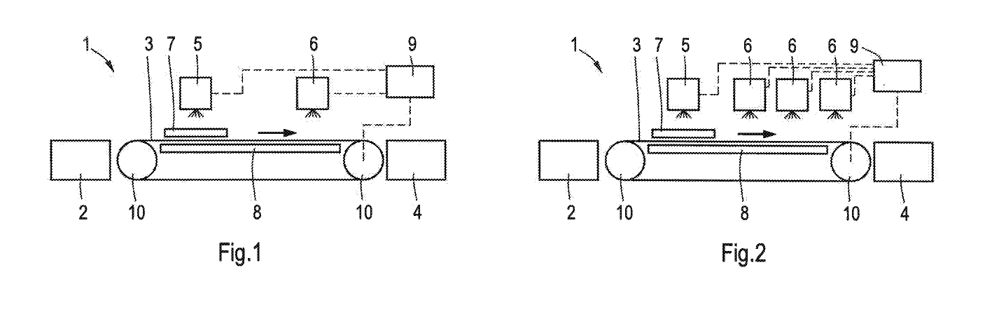

FIG. 1 shows an embodiment of an apparatus 1 for manufacturing a decorative panel. Furthermore, FIG. 1 illustrates an embodiment of a method of decorating a panel. The apparatus 1 is suitable for manufacturing decorative panels in a continuous manner and comprises a loading station 2, a carrier in the form of an endless conveyor belt 3 and an unloading station 4. A stationary décor printing station 5 and a stationary embossment printing station 6 are located along the conveyor belt 3. The stationary embossment printing station 6 is located downstream of the stationary décor printing station 5.

Under operating conditions of the apparatus 1 panels 7 are supplied from the loading station 2 to the conveyor belt 3. Each of the panels 7 is transported along both printing stations 5, 6. The décor printing station 5 comprises a digitally controlled décor printing module which prints a decorative basic pattern onto the panel 7 that is present on the conveyor belt 3 at the décor printing station 5. The embossment printing station 6 comprises a digitally controlled embossment printing module which prints a curable substance onto the panel 7. In more general terms, the décor printing module is a first printing module for performing a first printing step and the embossment printing module is a second printing module for performing a second printing step. The first printing module may be movable with respect to the stationary printing station 5 and the second printing module may be movable with respect to the stationary embossment printing station 6.

After the second printing step the panel 7 leaves the conveyor belt 3 towards the unloading station 4 for further treatment of the panel 7, for example for curing the pattern of curable substance on the panel 7. The apparatus 1 may be provided with vacuum grippers (not shown) for placing a panel 7 from the loading station 2 onto the conveyor belt 3 and transferring a panel 7 from the conveyor belt 3 to the unloading station 4, but alternative transfer systems are conceivable.

The apparatus 1 comprises a retainer in the form of a vacuum system 8 for drawing the panel 7 to the conveyor belt 3. As a consequence, the panel 7 is kept at a fixed position on the conveyor belt 3 when passing the panel 7 along the printing stations 5, 6. In other words, during the step of printing the decorative basic pattern and the step of printing the curable substance as well as between these steps the panel 7 is hold at a fixed position with respect to the conveyor belt 3.

The conveyor belt 3 and the printing modules at the printing stations 5, 6 are controlled by a controller 9. The conveyor belt 3 is driven continuously in this case, but in an alternative embodiment the conveyor belt 3 may be stopped or decelerated to a lower speed when the panel 7 to be printed arrives at the corresponding printing stations 5, 6. The controller 9 is provided with a storage unit including a lookup table which contains coordinates of the decorative basic pattern to be printed on the panel 7 by the décor printing module. The same lookup table is used for controlling the embossment printing module. Consequently, the curable substance can be printed exactly onto the decorative basic pattern or on portions thereof. In this way an embossment-in-register textured surface can be created. This is, however, not necessary; the patterns printed in the first printing step and in the second printing step may be shifted with respect to each other, for example.

Covering only a portion of the decorative basic pattern with the curable substance may be advantageous for esthetical reasons. For example, it appears that in case of decreasing line thickness in the decorative basic pattern a more than proportionally smaller amount of curable substance on top of the line creates attractive effects, for example in case that such a line imitates a wood nerve.

It is also possible that the second printing step is performed such that the pattern that is printed in the second printing step is positioned next to a pattern which is printed in the first printing step. For example, the decorative basic pattern has an area which represents a wood nerve and a curable substance is printed next to the wood nerve. This means that the resulting panel has a depression at the wood nerve. It is clear that the method and apparatus also provides the opportunity to create an elevation at the wood nerve, if desired.

Referring to FIG. 1, it is noted that any detection means for detecting the coordinates of the decorative basic pattern on the panel 7, such as cameras, between the décor printing station 5 and the embossment printing station 6 are omitted. Additionally, it is neither necessary to calculate new coordinates for a new lookup table that could be used for controlling the embossment printing module. This allows to manufacture decorative panels in a rapid continuous process, for example at speeds between 0 and 300 m/minute or higher, possibly dependent on the width and length of the belt 3. Experiments have shown that a belt 3 of which the upper surface has a width of about 1 m and a length of about 3 m may run at a speed of 120 m/min up to 180 m/min, whereas the accuracy in length and width direction is less than 5 μm. The accuracy achieved in a direction perpendicular to the upper surface of the belt 3 is less than 100 μm.

In order to keep the relative positions of the panel 7 and the décor printing station 5, on the one hand, and the panel 7 and the embossment printing station 6, on the other hand, equal, the conveyor belt 3 is controlled such that the panel 7 passes both printing stations 5, 6 at preset or fixed positions with respect to a reference point. The apparatus 1 is provided with an actuator (not shown) for adjusting the position of the conveyor belt 3 in a lateral direction with respect to its conveying direction. Furthermore, the apparatus 1 comprises return rollers 10 that guide the endless conveyor belt 3. The return rollers 10 are rotatable about shafts of which the ends can be displaced in a direction transversely with respect to the shafts so as to compensate the conical configuration that conveyor belts have in practice. As a result, a substantially constant tension over the width of the conveyor belt can be achieved. When tiny lines, for example representing wood nerves, are printed on the panel 7 at the décor printing station 5 a curable substance can be printed over the line at the embossment printing station 6 very accurately, or very accurately adjacent or close to a nerve.

If the conveyor belt 3 is driven at a fixed speed the embossment printing module may follow a similar path as the décor printing module, but with a certain time delay. The delay depends on the speed of the conveyor belt 3.

The speed of the conveyor belt 3 may vary. For example, if at the second printing station 6 a curable substance is printed in order to create an elevated surface, the speed of the conveyor belt 3 at the second printing station 6 may be lower than at the first printing station 5 since a higher quantity of printed matter may be required than for printing a basic pattern at the first printing station 5. For example, the speed is 10 m/min when the panel 7 is at the first printing station 5 and 2 m/min when the panel 7 is at the second printing station 6.

Referring to FIG. 1, it is conceivable to perform additional steps between printing the decorative basic pattern and printing the curable substance. For example, it is possible to apply a protecting layer onto the panel 7, for example a varnish including anti-wear particles. The protecting layer is not limited to the decorative basic pattern, but may cover the whole upper surface of the panel 7. Subsequently, at the embossment printing station 6 a curable substance may be printed onto the panel 7, possibly after curing or partly curing the protecting layer. Partly curing may be beneficial concerning adhesion of the different layers. Anti-wear particles may also be added to the curable substance pattern. In a specific embodiment the anti-wear particles in the protecting layer may be larger than those used in the curable substance. The anti-wear particles in the protecting layer may have abrasion resistant properties whereas the anti-wear particles in the curable substance may have scratch resistant properties.

The decorative basic pattern or a basic textured pattern can be printed by using water-based or solvent-based ink, UV curable ink, varnish, color ink, transparent ink or the like. The curable substance to be printed by the embossment printing module may be a photo-polymeric ink or an alternative substance. The medium that is printed on the panel 7 at the décor printing station 5 may be adapted to the properties of the panel 7, for example the ink absorbance properties of the panel 7. Similarly, the substance that is printed on the panel 7 at the embossment printing station 6 may be adapted to the properties of the medium that is printed at the décor printing station 5, for example the ink absorbance properties of the substance to be printed at the embossment printing station 6. Furthermore, the viscosity and other properties of the materials to be printed as well as ambient conditions may be of influence on the characteristics of the pattern to be printed, such as flowing behavior of the matter on the panel 7. The controller 9 is provided with a calculation module for calculating the required amount of ink, polymer, etc.

The décor printing module and the embossment printing module may be provided with print heads of the following types, but are not limited to these: ink jet print heads, valve jet print heads, piezo-controlled print heads, toner-based print heads. Furthermore, printing techniques like silk screen printing, lithography-based printing or laser printing are applicable.

The panels to be printed may be made of different materials, for example MDF, HDF, wood, polymeric composite, WPC, LVT, PVC, carton, textile, carpet tiles, ceramic, stone, metal or the like. Furthermore, the apparatus 1 can be designed for panels 7 of different shapes and/or dimensions. The products may be suitable for use as floor panels, wall panels, ceiling panels, furniture, packaging etc. The resulting panels may be large intermediate products that still must be cut into pieces, after which the pieces may be provided with locking means, such as tongues and grooves. The panel may also be a continuous sheet, which is printed in a roll-to-roll process, for example.

FIG. 2 shows an alternative embodiment of the apparatus 1. In this case the apparatus 1 is also provided with one décor printing station 5, but with three embossment printing stations 6. The embossment printing stations 6 build-up a curable substance in several steps. Between the successive embossment printing stations 6 the substance may be partly or fully cured. Each embossment printing module is controlled on the basis of the same lookup table of the coordinates of the decorative basic pattern. It is possible that the amount of curable substance that is printed by the embossment printing modules differs between the individual embossment printing stations 6. For example, in case of embossing-in-register thick lines may be covered by three layers of curable substance printed by three embossment printing modules, whereas thin lines may be covered by only two layers of curable substance printed by two embossment printing modules. Differences can also be created by changing drop size, viscosity and other properties.

As described hereinbefore, it is not necessary that the patterns which are printed at the printing stations 6 exactly match with the decorative basic pattern. The patterns printed at the individual printing stations 6 may even vary. Nevertheless, the apparatus 1 provides the opportunity to create a predetermined positional relationship between the decorative basic pattern and the patterns of the curable substance, on the basis of a reference set of coordinates which is used at different printing stations 5, 6. The embossing stations 6 may also print different types of substances in different patterns, for example a gloss substance in a certain pattern and a matt substance in a deviating pattern.

The décor printing module and/or the embossment printing module may be movable or stationary, depending on the type of patterns to be printed. For example, if a passing panel 7 should be decorated with a single depressed grout line in longitudinal direction, i.e. in the direction of movement of the belt 3, the décor printing station 5 may print a grout line on the panel and the embossing station 6 may print a curable substance adjacent to the grout line such that the resulting panel 7 obtains a depression at the grout line. In such a case the printing modules may be stationary with respect to a reference point.

Furthermore, it is conceivable that the panels 7 pass a single embossment printing station 6 more than once. For example, referring to FIG. 1 a panel 7 may leave the conveyor belt 3 at the unloading station 4 and transferred back to the loading station 2 in order to be supplied to the conveyor belt 3 once again. When passing the décor printing station 5 the décor printing module is not activated, but when passing the embossment printing station 6 a next layer is printed by the embossment printing module onto the panel 7.

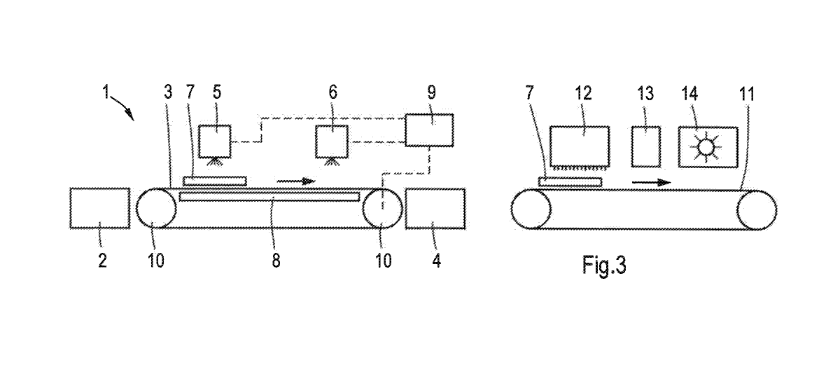

FIG. 3 shows an alternative embodiment of the apparatus 1. In this case the panel 7 is transferred to another conveyor 11 via the unloading station 4. A first printing pattern is printed at the first printing station 5 and a second printing pattern is printed at the second printing station 6. The second printing station 6 prints a liquid or adhesive on the panel 7. A powder unit 12 can be controlled to spread a powder over the passing panel 7. A part of the powder sticks to the liquid of the second printing pattern and another part of the powder falls beside of the printed substance and will be removed by a suction device 13. Hence, the powder only sticks to the liquid or adhesive at the second printing pattern. If embossment-in-register is desired the first and second printing patterns coincide. Alternatively, the abundant powder is removed by an air flow, for example by means of an air blade, air knife or air gun. The powder may comprise glitter particles, anti-wear particles like corundum particles, glass beads, silica or the like. The powder may comprise a thermographic or swelling powder and melted into a single mass which is elevated above the initial upper surface of the panel 7. It is conceivable that the liquid and powder together form a curable substance or the powder itself forms a curable substance adhering to the panel upon curing. In the latter case, the liquid may partly or entirely disappear in a curing step afterwards, for example by evaporation.

The thermographic powder may be a thermosetting powder, possibly containing a blowing agent. The powder grain size may have a predetermined variation and the powder can be pigmented, transparent or the like. Alternatively, the powder may be an ionomer, for example Surlyn. Applying an ionomer powder is advantageous since it does not only form a textured pattern upon curing, but it also provides anti-wear properties. This means that no additional anti-wear particles are required. Nevertheless, a combination of ionomer powder and anti-wear particles may be applied in order to obtain an optimal wear resistant textured surface.

In general terms, the invention is also related to a method of manufacturing a panel having a textured surface, comprising the steps of supplying a panel, printing a liquid onto the panel in a predefined pattern, providing a curable powder to the liquid, curing the powder, hence forming the panel, wherein the powder comprises an ionomer, for example Surlyn. This method can be combined with other steps as described hereinbefore, for example printing the liquid pattern in a positional relationship with a decoration pattern, removing abundant powder, etc. The powder may also comprise anti-wear particles such that after curing the ionomer the particles are embedded in the ionomer layer.

The invention is also related to a method of manufacturing a panel having a textured surface, comprising the steps of supplying a panel, applying a powder on the panel, printing a liquid onto the panel including the powder in a predefined pattern such that the powder is retained at the liquid pattern, removing abundant powder and curing the powder or curing the liquid and the powder, hence forming the panel. The powder may comprises an ionomer, for example Surlyn. The powder may also comprise anti-wear particles such that after curing the ionomer the particles are embedded in the ionomer layer. The step of removing abundant powder may be performed before or after the step of curing.

Several types, shapes and dimensions of the powder are conceivable. For example, metallic resin powder which creates a metallic effect after melting, lustrous resin powder in which lustrous particles are added to the powder, anti-static powder which avoids build-up of electrostatic charge and powders which generate pearlescent effect, matt effect or odour effect. The powder may contain release agents like wax or a gel component for improving cohesion to the polymer melt.

FIG. 3 shows, that the curable substance including the powder is cured at a curing station 14, which may comprise a UV-lamp, a UV-laser, a lamp generating optical radiation, a gas-discharge lamp, IR heating, a normal heater or an electron-beam heater, for example. Preferably, curing energy is concentrated to the curable substance and/or an adjacent portion of the panel to which the substance must be adhered. In case of using UV ink as a liquid for receiving thermographic powder it is possible to preheat the panel and ink to initiate melting before starting UV curing. After UV curing certain thermographic powders are not affected by possible further heat treatments.

It is also possible to control heating such that the melted substance starts to boil. Consequently, an irregular surface will arise which creates a matt surface effect. This provides the opportunity to create a glass-matt effect on the panel 7.

Furthermore, it is noted that the powder unit 12, the suction device 13 and the curing station 14 can also be placed along the accurate conveyor belt 3, but this is not necessary since the treatments need less accuracy than the printing steps. In an alternative embodiment the powder may be added at several successive stations, wherein the grain size of the powders may differ between the stations. For example, a powder having a grain size of 150 μm is sprinkled over the panel 7 at a first powder unit and a powder having a grain size of 50 μm at a second powder unit. A combination of different grain sizes of the thermographic powder may increase the packing density of the resulting substance upon curing. Due to increased density the powders can be melted faster since air inclusions, which typically have insulation properties, are minimized. The resulting melted substance appears to be homogeneous and obtains a smooth surface.

Furthermore, the powder may be pressed into the liquid or adhesive after sprinkling, for example by means of a roller, a belt, a plate or the like. Due to pressing the powder into the liquid, the density of the powder increases and the adherence of the powder to the liquid improves.

It is noted that the liquid which is printed by the embossing station 6 may have primer properties for improved adherence between the powder and the panel 7 upon curing. For example, in case of applying an ionomer powder on a panel having a polypropylene surface an adherence promotor can be added to the liquid.

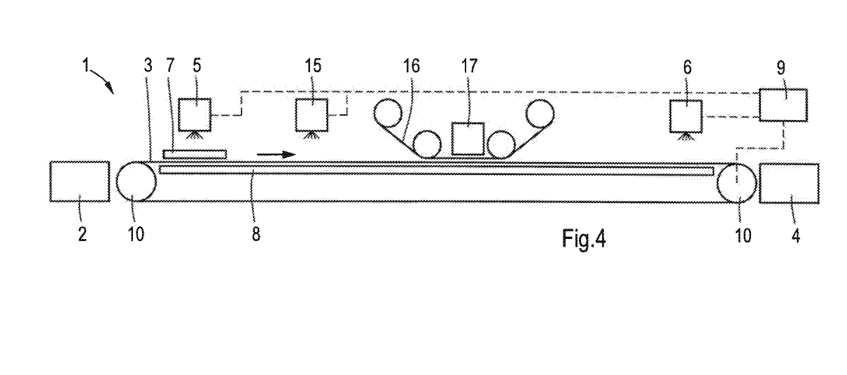

FIG. 4 shows an alternative embodiment of the apparatus 1, wherein intermediate steps are performed between printing the decorative basic pattern at the décor printing station 5 and printing the curable substance at the embossment printing station 6. After the panel 7 has left the décor printing station 5 it arrives at a toner printing station 15. A toner is printed on the basis of the same lookup table which is also used for controlling the décor printing module at the décor printing station 5. Then the panel 7 is coated by a metallized transfer foil 16 by means of a calander coating system. In the embodiment as shown in FIG. 4 the transfer foil is rolled-up after curing by means of a curing element 17. Then, a next printing step is printed onto the panel 7 at the embossment printing station 6. In this case the décor printing station 5, the toner printing station 15 and the embossment printing station 6 are located along the same accurate conveyor belt 3. They use the same lookup table for controlling the individual printing modules, hence achieving a rapid manufacturing process. Although not shown in FIG. 4, the curable substance will be cured after leaving the conveyor belt 3 so as to form decorative panels. Alternatively, the curable substance is formed by printing a liquid at the embossment printing station 6 and sprinkling a powder thereon, as described in relation to the embodiment corresponding to FIG. 3. The powder may also comprise anti-wear particles.

The thickness of the curable substance or the resulting textured pattern on the panel 7 may vary, but in general the thickness may be 5-1000 μm, preferably between 50 en 500 μm or even more preferably between 80 and 250 μm. The thickness may also be related to the size of additional particles like anti-wear particles or pigmented particles, that may be contained in the curable substance. The width and/or height of the textured pattern in the plane of the panel 7 is preferably larger than the size of anti-wear particles or other particles. In general, from esthetical point of view it may be undesired that any particles project beyond a boundary of a textured area on the panel 7.

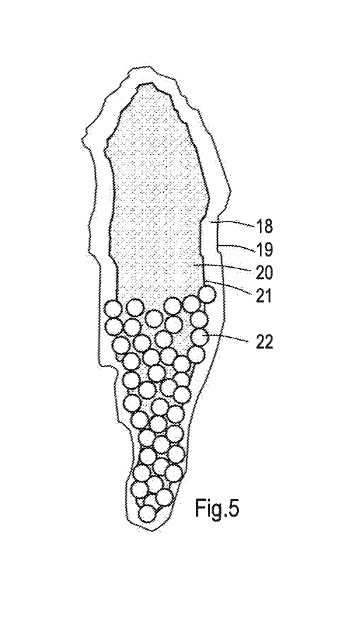

As mentioned hereinbefore, the method and apparatus provide the opportunity to perform a first and second printing step at a predetermined positional relationship. The carrier or conveyor belt 3 functions accurately such that the first and second printing steps can be based on the same reference set of coordinates without the necessity of monitoring the position of the pattern printed in the first printing step. It is also described that in the second printing step a curable substance may be printed, possibly by means of first printing a liquid and sprinkling a powder thereon. This provides the possibility to create a textured surface on the panel 7, possibly but not necessarily in-register with an underlying decorative basic pattern. For example, a panel imitating a brushed wood plank does not have an entirely embossed-in-register pattern. Furthermore, the second printing step may print a similar pattern as the first printing step, but at a certain distance thereof, not caused by a lack of accuracy, but deliberately. This is illustrated with reference to FIG. 5.

FIG. 5 shows a part of an upper surface of a panel that is decorated by means of the method. In the first printing step a first area 18 having a first border or contour 19 is printed onto the panel 7. The first area 18 may represent a wood nerve of a wood plank and an ink may be used as printing substance. In the second printing step a second area 20 is printed onto the first area 18 and has a second border or contour 21. The printing substance of the second area 20 is a liquid onto which thermographic powder 22 is applied afterwards such that an elevated surface is created at the first area 18.

It may be desired in practice to keep the first contour 19 clearly visible after finishing the panel 7. If the second area 20 overlaps the first contour 19 this might lead to a vague first contour 19, even if the substance of the resulting second area 20 is transparent. In order to avoid that the liquid of the second area 20 flows over the contour of the first area 18, the coordinates that were used for the first printing step are adapted such that the liquid of the second area 20 is printed within the first area 18 at a certain distance from the first contour 19 of the first area 18. The distance to be chosen depends on the viscosity of the liquid of the second area 20. Furthermore, the distance depends on the particle size of the powder 22. FIG. 5 illustrates that particles may project outside the second contour 21 of the second area 20, but remain within the first contour 19 of the first area 18. Hence, the distance between the contours 19, 21 of both areas 18, 20 should be such that particles which stick at the edge of the second area 21 do not extend over the edge of the first area 18 after curing. In case of using a swelling powder the distance between both contours 19, 21 can be still higher. When applying a powder having extremely small particle size, any projection of particles outside the second contour 19 is minimized and the distance between the first and second contours 19, 21 may be minimized.

The powder 22 can be supplied relatively inaccurately by means of scattering over the panel 7 and removing the abundant powder 22 before curing, but it is also possible to print the powder at the second area 20 accurately in a third printing step, for example by means of a toner-based printer module. Alternatively, the powder 22 is supplied by means of an electrostatographic process, such as xerography, iconography, laser printer technology, or the like.

If it is desired to create a higher surface level outside the first area 18, the second printing step should print a liquid outside the first contour 19 of the first area 18. In that case the coordinates that were used in the first printing step can be easily adjusted for performing the second printing step such that printing of the liquid stops at a predetermined distance from the first contour 19 outside the first area 18.

Although the embodiment of FIG. 5 illustrates a second printing step which is followed by sprinkling or printing of thermographic powder 22, it is also conceivable that a curable substance is printed at the second area 20 without the necessity of adding a powder afterwards.

Furthermore, in order to avoid flow over pattern edges as illustrated in FIG. 5 it is also possible to print a repellent or release agent. Referring to FIG. 5, it is again possible to print the first area 18 in the first printing step. In the second printing step a repellent or release agent can be printed accurately on the first contour 19 and possibly also within the first contour 19, after which in a third printing step a curable substance can be printed outside the first area 18. The repellent matter at the first contour 19 prevents the curable substance or melting thermographic powder from spilling over the first contour 19 to the first area 18. Afterwards the repellent agent may be removed or remain on the panel 7. The repellent agent may be made of silicones. If the repellent or release agent is removed afterwards, it is allowable that in the third printing step the curable substance is also printed inside the first area 18, such that less accurate printing of the curable substance is possible. Numerous variations of the processes are possible with the method and the apparatus due to the possibility of accurate printing without monitoring the relative position of any pattern on the panel 7 intermediately.

Flow over pattern edges during curing may also be avoided by manipulating the curing conditions, for example by means of quickly cooling after melting thermographic powder in order to increase the viscosity of the melted substance rapidly.

Instead of imitating a wood nerve as described hereinbefore, it is possible to create a textured surface on a panel in the form of bevelled side edges in order to create a V-groove between adjacent panels. Such a texture can be created by for example printing a number of layers of liquid or adhesive onto each other which layers become narrower in a direction away from the panel, whereas a thermographic powder is sprinkled over the layers. After curing the resulting substance a panel including inclined opposite side edges arise. Of course, numerous alternative printing edges are conceivable to achieve the same result.

The method of manufacturing further provides the opportunity to create different printing layers next or adjacent to each other instead of or in addition to printing layers onto each other, for example in order to create areas of different gloss levels. Nevertheless, the method can be used to make a textured surface having varying gloss levels.

Furthermore, it is possible to print liquids of different properties on a panel by means of a plurality of printing modules. For example, the liquids may vary in rate of powder acceptance such that after sprinkling a thermographic powder and removing abundant powder, different powder densities are present on the panel. After curing the resulting substance, the texture will vary in height direction.

The rate of powder acceptance can also be influenced by the liquid absorbance capacity of the panel. If the liquid is absorbed quickly, it will absorb less powder, resulting in a relatively low elevation.

In another additional manufacturing step a finishing layer may be applied on the panel, for example a layer containing wear resistant particles.

From the foregoing it will be apparent that the invention provides an efficient method of decorating panels and an apparatus for that.

Due to the accurate functioning of the carrier it is possible to repeat several printing steps in an accurate way and to create numerous variations of possible successive processing steps. It is, for example, possible to manufacture a panel which imitates a wood nerve that is depressed and more glossy with respect to its surrounding surface. The following process may be performed. First printing a wood nerve pattern of liquid on the panel, then scattering a glitter powder on the liquid and subsequently removing abundant glitter powder. Then printing a second pattern of liquid outside and adjacent to the wood nerve pattern, scattering a matt powder having thermographic properties on the second pattern and removing abundant matt powder. After melting and/or curing the liquids and/or powders the panel surface will be higher and have a matt appearance outside the wood nerve whereas the depressed wood nerve will have a glossy appearance.

The invention is not restricted to the above-described embodiments as shown in the drawings, which can be varied in several ways without departing from the scope of the invention. The variations of printing, particularly relating to thermography, may be applied in a separate way, independent from the method having at least two printing steps and using a different apparatus than described hereinbefore.

1. A method of decorating a panel, comprising: supplying a panel to a carrier, performing at least a first printing step using a first printing module and performing a second printing step using a second printing module, wherein the first and second printing steps are performed according to a predetermined positional relationship to form the decorated panel, and wherein during and between the first and second printing steps the panel is held at a substantially fixed position with respect to the carrier.

2. The method according to claim 1, and positioning the carrier at preset positions with respect to a reference point during the first and second printing steps.

3. The method according to claim 2, wherein during the first and second printing steps positioning the carrier includes following preset paths with respect to the reference point.

4. The method according to claim 3, wherein the preset paths extend behind each other.

5. The method according to claim 1, wherein the first printing step comprises printing a decorative basic pattern on the panel and the second printing step comprises printing a curable substance on the panel, the method further comprising curing the curable substance.

6. The method according to claim 5, wherein printing the curable substance comprises printing over at least a part of said decorative basic pattern or adjacent to said decorative basic pattern.

7. The method according to claim 1, and further comprising at least an intermediate step of applying an additional layer onto the panel being performed between the first and second printing steps.

8. The method according to claim 1, and positioning the carrier at fixed positions with respect to a reference point during the first and second printing steps.

9. An apparatus for manufacturing a decorative panel, comprising a carrier configured to support a panel, a retainer configured to hold the panel at a substantially fixed position with respect to the carrier, a décor printing module configured to print a decorative pattern on a panel, an embossment printing module configured to print a curable substance, a controller configured to displace the carrier, the décor printing module and the embossment printing module with respect to each other and configured to control the amount of printing by the printing modules, wherein the controller is provided with a storage unit configured to store coordinates of the pattern which are used for displacing the carrier, the décor printing module and the embossment printing module with respect to each other.

10. The apparatus according to claim 9, wherein the décor printing module is part of a stationary décor printing station and the embossment printing module is part of a stationary embossment printing station, whereas the carrier comprises an endless conveyor belt, along which the printing stations are located.

11. The apparatus according to claim 10, wherein the retainer comprises a vacuum system configured to draw a panel to the conveyor belt.

12. The apparatus according to claim 10, wherein the apparatus comprises an actuator configured to move the conveyor belt in a lateral direction with respect to its conveying direction so as to keep the conveyor belt at a predetermined track.

13. The apparatus according to claim 9, wherein a curing station is present upstream or downstream of the embossment printing module.

14. The apparatus according to claim 13, wherein a powder unit is configured to spread a powder over a passing panel present between the embossment printing module and the curing station.

15. The apparatus according to claim 9, wherein the décor printing module comprises a print head configured to print a liquid and the embossment printing module comprises a print head configured to print a powder.
